(19) United States
(12) Patent Application Publication
(10) Pub. No.: US 2024/0212923 A1
(43) Pub. Date: Jun. 27, 2024

(54) COIL COMPONENT

(71) Applicant: SAMSUNG ELECTRO-MECHANICS CO., LTD., Suwon-si (KR)

(72) Inventors: Soon Kwang Kwon, Suwon-si (KR); Dong Hwan Lee, Suwon-si (KR); Boum Seock Kim, Suwon-si (KR); Jung Wook Seo, Suwon-si (KR)

(73) Assignee: SAMSUNG ELECTRO-MECHANICS CO., LTD., Suwon-si (KR)

(21) Appl. No.: 18/538,666

(22) Filed: Dec. 13, 2023

(30) Foreign Application Priority Data
Dec. 21, 2022 (KR) 10-2022-0180365

(51) Int. Cl. H01F 27/29; H01F 27/32

(52) U.S. Cl. CPC H01F 27/292; H01F 27/324; H01F 27/323

(57) ABSTRACT

The coil component according to an aspect of the present disclosure includes: a body having one surface and the other surface opposing each other, and a plurality of side surfaces connecting one side to the other side; a coil buried in the body and having an end exposed to the side surface of the body; an external electrode including a connection portion disposed on the side surface of the body and connected to the end of the coil, and an extension portion extending from the connection portion to one surface of the body; and a groove formed in one surface of the body and having a bottom surface, substantially parallel to one surface of the body, and an internal wall connecting the bottom surface to one surface of the body, wherein the extension portion extends along the internal wall and the bottom surface of the groove.

### CROSS-REFERENCE TO RELATED APPLICATION(S)

This application claims benefit of priority to Korean Patent Application No. 10-2022-0180365 filed on Dec. 21, 2022, in the Korean Intellectual Property Office, the disclosure of which is incorporated herein by reference in its entirety.

### TECHNICAL FIELD

The present disclosure relates to a coil component.

An inductor, a type of coil component, is a representative manual electronic component used in electronic devices along with a resistor and a capacitor.

On the other hand, a coil component may be generally mounted and used in a substrate, and an electrode may peel off due to repeated vibrations, impacts, and bending.

Therefore, the importance of bending strength characteristics is increasing to improve reliability of components.

### SUMMARY

An aspect of the present disclosure is to provide a coil component having improved bending strength characteristics.

According to an aspect of the present disclosure, provided is a coil component including: a body having one surface and the other surface opposing each other, and a plurality of side surfaces connecting one side to the other side; a coil buried in the body and having an end exposed to the side surface of the body; an external electrode including a connection portion disposed on the side surface of the body and connected to the end of the coil, and an extension portion extending from the connection portion to one surface of the body; and a groove formed in one surface of the body and having a bottom surface, substantially parallel to one surface of the body, and an internal wall connecting the bottom surface to one surface of the body, wherein the extension portion extends along the internal wall and the bottom surface of the groove.

According to the present disclosure, bending strength characteristics of a coil component may be improved, thereby preventing peel-off of an external electrode.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first embodiment of the present disclosure;

FIG. 2 is a view illustrating a cross-section taken along line I-I′ of FIG. 1;

FIG. 3 is a modified example of a coil component according to a first example embodiment, which is a view illustrating a cross-section corresponding to a cross-section taken along line I-I′ of FIG. 1;

FIG. 4 is a perspective view schematically illustrating a coil component according to a second example embodiment of the present disclosure; and

FIG. 5 is a view illustrating a cross-section taken along line II-II′ of FIG. 4.

### DETAILED DESCRIPTION

The term used herein is for the purpose of describing particular embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof. Furthermore, throughout the specification, the term “on” means positioning above or below the object portion, but does not essentially mean positioning on the upper side of the object portion based on a gravity direction.

The terms “coupled to,” “combined to,” and the like, may not only indicate that elements are directly and physically in contact with each other, but may also include the configuration in which the other element is interposed between the elements such that the elements are also in contact with the other component.

In the drawings, sizes and thicknesses of elements illustrated in the drawings are indicated as examples for ease of description, and example embodiments in the present disclosure are not limited thereto.

In the drawings, an X-direction may be defined as a first direction or an L direction, a Y-direction may be a second direction or a W direction, and a Z-direction may be a third direction or a T direction.

In the descriptions described with reference to the accompanied drawings, the same elements or elements corresponding to each other will be described using the same reference numerals, and overlapping descriptions will not be repeated.

In electronic devices, various types of electronic components may be used, and various types of coil components may be used between the electronic components to remove noise, or for other purposes.

In other words, in electronic devices, a coil component may be used as a power inductor, a high frequency (HF) inductor, a general bead, a GHz bead, a common mode filter, and the like.

### First Example Embodiment

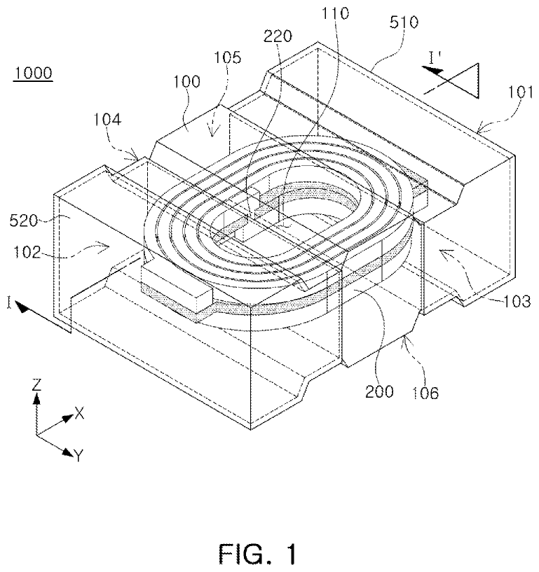

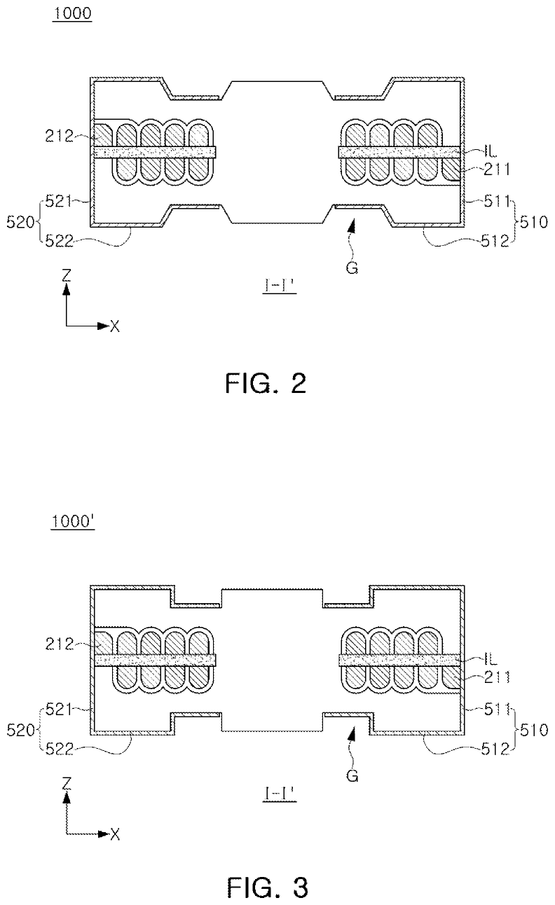

FIG. 1 is a perspective view schematically illustrating a coil component according to a first embodiment of the present disclosure. FIG. 2 is a view illustrating a cross-section taken along line I-I′ of FIG. 1. FIG. 3 is a modified example of a coil component according to a first example embodiment, which is a view illustrating a cross-section corresponding to a cross-section taken along line I-I′ of FIG. 1.

Referring to FIGS. 1 and 2, a coil component 1000 according to an example embodiment of the present disclosure includes a body 100, a coil 200, and first and second external electrodes 510, 520.

The body 100 forms an appearance of the coil component 1000 according to an example embodiment of the present disclosure. The body 100 may be formed to have a hexahedral shape as a whole.

Hereinafter, the present disclosure will be described on the premise that the body 100 has a hexahedral shape. However, this description does not exclude coil components including bodies formed in shapes other than the hexahedral shape from the scope of the present disclosure.

Referring to FIGS. 1 and 2, the body 100 includes a first surface 101 and a second surface 102 opposing each other in the X-direction, a third surface 103 and a fourth surface 104 opposing each other in the Y-direction, and a fifth surface 105 and a sixth surface 106 opposing each other in the Z-direction. Each of the first to fourth surfaces 101, 102, 103 and 104 of the body 100 corresponds to a side surface of the body 100 connecting the fifth surface 105 and the sixth surface 106 of the body 100. Hereinafter, one surface and the other surface of the body 100 opposing each other may refer to the sixth surface 106 and the fifth surface 105 of the body 100, respectively, and a plurality of side surfaces connecting one surface to the other surface of the body 100 may refer to the first to fourth surfaces 101, 102, 103 and 104.

The body 100 may, for example, be formed so that the coil component 1000 according to some embodiments has a length of 2.0 mm, a width of 1.2 mm, and a thickness of 0.65 mm, but the present disclosure is not limited thereto. On the other hand, since the above-described numerical value does not take into account an error in the process, a case of having a numerical value different from the above-described numerical value due to the error in the process also belongs to the scope of the present disclosure.

Referring to FIG. 2, at least one groove G is formed on one surface of the body 100. The groove is formed in an upper surface or a lower surface of the body 100, and penetrates through a portion of the body 100. A plurality of grooves G may be formed to be spaced apart from the upper surface or the lower surface of the body 100. For convenience, hereinafter, as illustrated in FIG. 2, example embodiments of the present disclosure will be described based on two grooves G formed on the one surface of the body.

The groove G is formed in a region between first and second external electrodes 510 and 520 described below, and may increase a current path between the first and second external electrodes 510 and 520 to prevent an electrical short-circuit between the first and second external electrodes 510 and 520. That is, in the case of some embodiments of the present disclosure in which the groove G is formed, a distance between the first and second external electrodes 510 and 520 along the surface of the body 100 may increase as compared to a case in which the groove G is not formed, thereby reducing the risk of an electrical short-circuit between the first and second external electrodes 510 and 520. Furthermore, as will be described below, the external electrodes 510 and 520 may extend into the groove G, which may alleviate a peel off phenomenon of the electrode.

The groove G may be formed by dicing a coil bar to which a plurality of bodies are connected and individualizing the bodies of a plurality of components, and then performing slit dicing on one surface of the body 100.

The groove G has a bottom surface, substantially parallel to one surface of the body 100, and an internal wall connecting the bottom surface to the one surface of the body 100. The internal wall may be parallel to first and second surfaces of the body 101 and 102, but the present disclosure is not limited thereto. For example, the internal wall may not be parallel to the first and second surfaces of the body 101 and 102, and a cross-section of the groove G may have a trapezoidal shape as illustrated in FIG. 2. In some embodiments of the present disclosure, a case in which the cross-section of the groove G is trapezoidal will be described.

The body 100 may include a magnetic material and a resin. Specifically, the body 100 may be formed by stacking one or more magnetic composite sheets including a resin and a magnetic material dispersed in the resin. However, the body 100 may have a structure other than a structure in which the magnetic material is dispersed in the resin. For example, the body 100 may include a magnetic material such as a ferrite.

The magnetic material may include a ferrite or metal magnetic powder particles.

Examples of the ferrite powder particles may include, for example, at least one selected from the group consisting of a spinel-type ferrite such as a Mg—Zn-based ferrite, a Mn—Zn-based ferrite, a Mn—Mg-based ferrite, a Cu—Zn-based ferrite, a Mg—Mn—Sr-based ferrite and a Ni—Zn-based ferrite, a hexagonal ferrite such as a Ba—Zn-based ferrite, a Ba—Mg-based ferrite, a Ba—Ni-based ferrite, a Ba—Co-based ferrite and a Ba—Ni—Co-based ferrite, a garnet-type ferrite such as a Y-based ferrite and the like, a Li-based ferrite, and combinations thereof.

The metal magnetic powder particles may include at least one selected from the group consisting of iron (Fe), silicon (Si), chromium (Cr), cobalt (Co), molybdenum (Mo), aluminum (Al), niobium (Nb), copper (Cu), and nickel (Ni) For example, the metal magnetic powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder, Fe—Cr-based alloy powder particles, Fe—Cr—Si-based alloy powder particles, Fe—Si—Cu—Nb-based alloy powder particles, Fe—Ni—Cr-based alloy powder particles, Fe—Cr—Al-based alloy powder particles, and combinations thereof.

The metal magnetic powder may be amorphous or crystalline. For example, the metal magnetic powder particles may include a Fe—Si—B—Cr-based amorphous alloy powder particles, but the present disclosure is not limited thereto.

Each of the ferrite and the metal magnetic powder particles may have an average diameter of about 0.1 μm to about 30 μm, but the present disclosure is not limited thereto.

The body 100 may include two or more types of magnetic materials dispersed in the resin. Here, the fact that magnetic materials are of different types denotes that magnetic materials dispersed in the resin are distinguished from each other by at least one of average diameter, a composition, crystallinity, and a shape.

The resin may include epoxy, polyimide, a liquid crystal polymer, alone or in combination, but the present disclosure is not limited thereto.

The body 100 includes a coil 200 described below and a core 110 penetrating through an internal insulating layer IL. The core 110 may be formed by filling a through-hole of the coil 200 with a magnetic composite sheet, but the present disclosure is not limited thereto.

The coil component according to some embodiments of the present disclosure may further include an internal insulating layer IL, and the internal insulating layer IL may have first and second coil patterns 211 and 212, described below, formed on both surfaces thereof, respectively, and may serve to support the first and second coil patterns 211 and 212.

The internal insulating layer IL may include an insulating material including a thermosetting insulating resin such as an epoxy resin, a thermoplastic insulating resin such as polyimide, or a photosensitive insulating resin, and the internal insulating layer IL may include an insulating material in which a reinforcing material such as a glass fiber or an inorganic filler is impregnated in the insulating resin. For example, the internal insulating layer IL may be formed of an insulating material such as prepreg, an Ajinomoto Build-up Film (ABF), FR-4, a Bismaleimide Triazine (BT) resin, and photoimageable dielectric (PID), but the present disclosure is not limited thereto.

The inorganic filler may include at least one selected from the group consisting of silica (SiO₂), alumina (Al₂O₃), silicon carbide (SiC), barium sulfate (BaSO₄), talc, mud, mica powder particles, aluminum hydroxide (Al(OH)₃), and magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), calcium zirconate (CaZrO₃), and combinations thereof.

When the internal insulating layer IL comprises an insulating material including a reinforcing material, the internal insulating layer IL may provide more excellent rigidity. When the internal insulating layer IL comprises an insulating material that does not include glass fibers, the internal insulating layer IL may be advantageous in thinning an entire thickness of the coil component 1000 according to an example embodiment of the present disclosure. When the internal insulating layer IL comprises an insulating material including a photosensitive insulating resin, the number of processes may be reduced, which may be advantageous in reducing production costs and may be advantageous in micro-hole processing.

The coil 200 is buried in the body 100 to express the characteristics of the coil component. For example, when the coil component 1000 of some embodiments is used as a power inductor, the coil 200 may serve to stabilize the power of an electronic device by storing an electrical field as a magnetic field and maintaining an output voltage. Both end portions of the coil 200 may be exposed to both end surfaces of the body 100, that is, the first and second surfaces 101 and 102 of the body 100.

The coil 200 may include a first coil pattern 211, a second coil pattern 212, and a via 220. The first coil pattern 211, the internal insulating layer IL, and the second coil pattern 212 may be formed such that they are sequentially stacked in the Z-direction of the body 100.

Each of the first coil pattern 211 and the second coil pattern 212 may be formed in a planar spiral shape. For example, the first coil pattern 211 may form at least one turn using the core 110 of the body 100 as an axis on one surface of the internal insulating layer IL (a lower surface of the IL based on FIG. 2). The second coil pattern 212 may form at least one turn using the core 110 of the body 100 as an axis on the other surface of the inner insulating layer IL (an upper surface of the IL based on FIG. 2). The first and second coil patterns 211 and 212 may be wound in the same direction.

The via 220 may pass through the internal insulating layer IL to electrically connect the first coil pattern 211 and the second coil pattern 212 and may come to contact into the first coil pattern 211 and the second coil pattern 212, respectively. Accordingly, the coil 200 according to some embodiments of the present disclosure may be formed as one coil generating a magnetic field in the Z-direction of the body 100 inside the body 100.

At least one of the first coil pattern 211, the second coil pattern 212, and the via 220 may include at least one conductive layer.

For example, when the second coil pattern 212 and the via 220 are formed by a plating method, the second coil pattern 212 and the via 220 may include a seed layer and an electrolytic plating layer, respectively. The seed layer may be formed by an electroless plating method or by a vapor deposition method such as sputtering. The electroplating layer may have a single layer structure or a multilayer structure. The electroplating layer having a multilayer structure may be formed in a conformal film structure in which one electroplating layer is covered by another electroplating layer, or may be formed in a shape in which another electroplating layer is stacked only on one surface of one electroplating layer. A seed layer of the second coil pattern 212 and a seed layer of the via 220 may be integrally formed so that no boundary may be formed between the seed layers, but the present disclosure is not limited thereto. An electroplating layer of the second coil pattern 212 and an electroplating layer of the via 220 may be integrally formed so that no boundary may be formed between the electroplating layers, but the present disclosure is not limited thereto.

For another example, when the first coil pattern 211 and the second coil pattern 212 are formed separately and then stacked on the internal insulating layer IL to form the coil 200, the via 220 may include a high melting point metal layer and a low melting point metal layer having a melting point lower than that of the high melting point metal layer. Here, the low melting point metal layer may include a solder including lead (Pb) and/or tin (Sn). At least a portion of the low melting point metal layer may be melted due to pressure and a temperature during collective stacking, and an intermetallic compound layer (IMC layer) may be formed on at least one of between the low melting point metal layer and the first coil pattern 211, between the low melting point metal layer and the second coil pattern 212, and between the high melting point metal layer and the low melting point metal layer.

Based on a direction of FIG. 2, for example, the first coil pattern 211 and the second coil pattern 212 may protrude from lower and upper surfaces of the internal insulating layer IL, respectively. In some embodiments, the second coil pattern 212 may be protruded from the upper surface of the insulating layer IL, and the first coil pattern 211 may be embedded in the lower surface of the insulating layer IL to expose the lower surface of the first coil pattern 211 from the lower surface of the insulating layer IL. In this case, since a concave portion may be formed on the lower surface of the first coil pattern 211, the lower surface of the internal insulating layer IL and the lower surface of the first coil pattern 211 may not be disposed on the same plane. As another example, as the first coil pattern 211 may be disposed on the lower surface of the internal insulating layer IL, a lower surface thereof may be exposed to the lower surface of the internal insulating layer IL, and as the second coil pattern 212 may be buried in the upper surface of the inner insulating layer IL, an upper surface thereof may be exposed to the upper surface of the inner insulating layer IL.

Ends of each of the first coil pattern 211 and the second coil pattern 212 may be exposed to the first and second surfaces 101 and 102 of the body 100, respectively. As the end exposed to the first surface 101 of the body 100 comes into contact with a first external electrode 510 described below, the first coil pattern 211 is electrically connected to the first external electrode 510. As the end exposed to the second surface 102 of the body 100 comes into contact with a second external electrode 520 described below, the second coil pattern 212 is electrically connected to the second external electrode 520.

Each of the first coil pattern 211, the second coil pattern 211, and the via 220 may include a conductive material such as copper (Cu), aluminum (Al), silver (Ag), tin (Sn), gold (Au), nickel (Ni), lead (Pb), titanium (Ti), or alloys thereof, but the present disclosure is not limited thereto.

The first and second external electrodes 510 and 520 are spaced apart from each other on an external surface of the body 100, and are connected to the coil 200, respectively. Specifically, the first external electrode 510 includes a first connection portion 511 disposed on the first surface 101 of the body 100 and connected to an end of the first coil pattern 211, and a first extension portion 512 extending from the first connection portion 511 to one surface or the other surface of the body 100. The second external electrode 520 includes a second connection portion 521 disposed on the second surface 102 of the body 100 and connected to an end of the second coil pattern 212, and a second extension portion 522 extending from the second connection portion 521 to one surface and the other surface of the body 100. The first extension portion 512 and the second extension portion 522 disposed on the one surface of the body 100 are spaced apart from each other to prevent a short circuit between the first external electrode 510 and the second external electrode 520.

A coil component may be generally mounted and used in a substrate, and an electrode may peel off due to repeated vibration, impact, and bending. This is because stress is concentrated on an edge interface of the body, and an electrode peel off phenomenon may be solved when the stress is dispersed to the center of the body. Accordingly, example embodiments according to the present disclosure are intended to newly devise a structure of the external electrode, thereby alleviating the electrode peel off phenomenon and improving the bending strength characteristics of the coil component.

Referring to FIG. 2, the extension portions 512 and 522 of the first and second external electrode extend to an interior of the groove G formed on the upper surface or the lower surface of the body 100. Specifically, the extension portions 512 and 522 of the external electrode may extend along an internal wall and a bottom surface of the groove G. By extending the extension portions 512 and 522 of the external electrode to the interior of the groove G, an area in which the external electrodes 510 and 520 are in close contact with the body 100 may increase, and stress may be dispersed to the center of the coil component due to the increase in the contact area.

The extension portions 512 and 522 may fill a portion of the groove G. For example, the extension portions 512 and 522 may be formed to fill a portion of the groove G. However, the present disclosure is not limited thereto, and the extension portions 512 and 522 may be in a form in which the entire groove G is charged. Specifically, when a depth (i.e., a length in the Z-direction) of the groove G formed in one surface of the body 100 is insufficient, the extension portions 512 and 522 of the external electrode may charge the entire groove G.

The extension portions 512 and 522 extending to the interior of the groove may correspond to a shape of the groove G. That is, the extension portions 512 and 522 extending to the interior of the groove may extend along the internal wall and the bottom surface of the groove G. Specifically, as described above, in an example embodiment of the present disclosure, since a cross-section of the groove G in the X-Z direction has a trapezoidal shape, the extension portions 512, 522 may extend to the interior of the groove G so as to correspond to the shape of a groove G having a trapezoidal shape.

The extension portions 512 and 522 may be in contact with the body 100 through the groove G.

On the other hand, the extension portions 512 and 522 may cover the bottom surface and the entire internal wall of the groove G, and in this case, with an increase in a length of the external electrode extension, a part in which the stress is generated moves to the center of the body, and the stress is dispersed. However, the present disclosure is not limited thereto, and a portion of the groove G may be not in contact with the extension portions 512 and 522. That is, the extension portion extending to the interior of the groove may not be in contact with a portion of the bottom surface or the internal wall of the groove G. Specifically, in this case, as in a second example embodiment of the present disclosure, which will be described below, an insulating layer 700 may extend to an interior of the groove G, and the insulating layer 700 may fill a portion of the groove G.

The external electrodes 510 and 520 may include a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

Meanwhile, although not illustrated in the drawings, each of the external electrodes 510 and 520 may include a first electrode layer and a second electrode layer formed on the first electrode layer. That is, each of the external electrodes 510 and 520 may have a structure of a plurality of layers. Specifically, a first external electrode 510 includes a first electrode layer in contact with an end of the first coil pattern 211 exposed to the first surface 101 of the body 100, and a second electrode layer formed on the first electrode layer. The second external electrode 520 includes a first electrode layer in contact with an end of the second coil pattern 212 exposed to the second surface 102 of the body 100, and a second electrode layer formed on the first electrode layer.

The first electrode layer and the second electrode layer may extend to the interior of the groove G. Furthermore, as described above, since the external electrodes 510 and 520 may fill a portion of the groove G and extend along the surface of the groove G, a portion of the first electrode layer and the second electrode layer may be disposed inside the groove G.

The first electrode layer may be a conductive resin layer formed by applying conductive powder particles including at least one of silver (Ag) or copper (Cu) and a conductive paste including an insulating resin to the sixth surface 106 of the body 100 and curing the same. Alternatively, the first electrode layer may be, for example, a metal layer formed of copper (Cu) electrolytic plating or sputtering. When the first electrode layer is a conductive resin layer, coupling force between the external electrodes 510 and 520 and the body 100 may be improved. When the first electrode layer is a metal layer, a total thickness of the external electrodes 510 and 520 may be reduced to reduce ae total thickness of components. The second electrode layer may include a nickel plating layer in which the first electrode layer is formed as a seed layer, and a tin plating layer disposed on the nickel plating layer.

An insulating film IF may be formed along surfaces of the first coil pattern 211, the internal insulating layer IL, and the second coil pattern 212. The insulating film IF is meant to protect and insulate respective coil patterns 211 and 212, and includes a known insulating material such as parylene. Any insulating material included in the insulating film IF may be used, and there is no particular limitation. The insulating film IF may be formed by vapor deposition or the like, but the present disclosure is not limited thereto, and the insulating film IF may be formed by stacking an insulating material of the insulating film on both surfaces of the inner insulating layer IL in which the first and second coil patterns 211 and 212 are formed. However, the above-described insulating film IF may be omitted in example embodiments of the present disclosure according to design needs.

FIG. 3 is a modified example 1000′ of a coil component according to the first example embodiment, which is a view illustrating a cross-section corresponding to a cross-section taken along line I-I′ of FIG. 1.

In the modified example, an internal wall of a groove G is substantially parallel to the first and second surfaces of the body 100. That is, as illustrated in FIG. 3, a cross-section of the groove G in the X-Z direction may have a rectangular shape. In this case, extension portions 512 and 522 may extend to an interior of the groove G along with the rectangular shape of the groove G.

Other details are substantially the same as those described above in the description of the first example embodiment, and detailed descriptions will be omitted.

### Second Example Embodiment

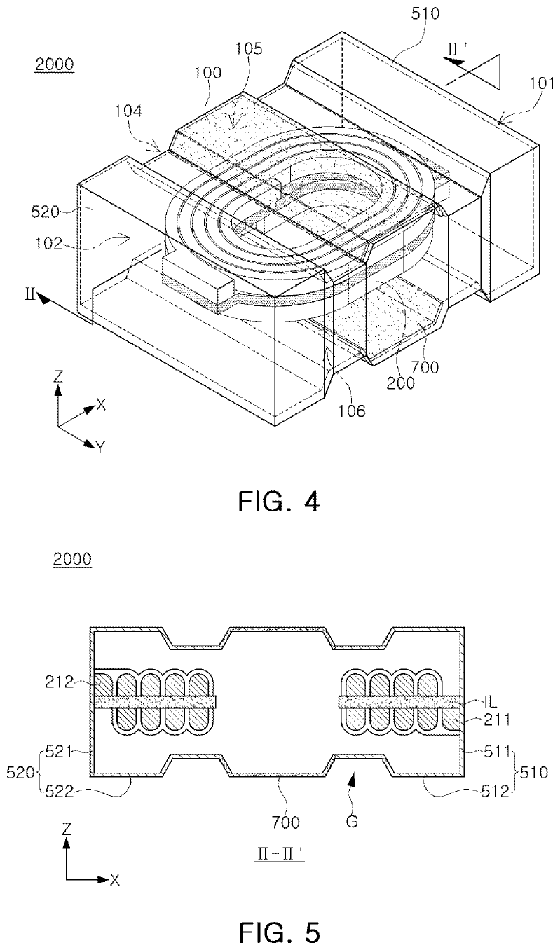

FIG. 4 is a perspective view schematically illustrating a coil component according to a second example embodiment of the present disclosure, and FIG. 5 is a view illustrating a cross-section taken along line II-II′ of FIG. 4.

Hereinafter, referring to FIGS. 4 and 5, a coil component 2000 according to the second example embodiment will be described, and differences from the coil component 1000 according to the first example embodiment will be described in detail.

The coil component 2000 according to the second example embodiment may further include an insulating layer 700. Specifically, referring to FIGS. 4 and 5, the insulating layer 700 may be disposed between first and second grooves G. Although FIGS. 4 and 5 illustrate that thicknesses of the insulating layer 700 and external electrodes 510 and 520 are identical to each other, this is for convenience of description, and the thickness of the insulating layer 700 may be different from the thicknesses of the external electrodes 510 and 520.

The insulating layer 700 may extend to an interior of the first and second grooves G. Specifically, the insulating layer 700 extending to the interior of the groove may extend along a surface of the groove G. Specifically, the insulating layer 700 may extend along surfaces of the internal walls of the first and second grooves G, and may not be in contact with bottom surfaces of the first and second grooves G. Alternatively, the insulating layer 700 may extend along the internal walls and the bottom surfaces of the first and second grooves G, but may not be in contact with a portion of the bottom surfaces thereof.

Accordingly, the insulating layer 700 may fill a portion of the first and second grooves G. The insulating layer 700 may be disposed in a portion of the groove G, thereby preventing the short-circuit between the first and second external electrodes 510 and 520.

The insulating layer 700 may be formed in the form of a conformal film corresponding to the shape of the groove G in view of increasing a current path between the first and second external electrodes 510 and 520, but the scope of the present disclosure is not limited thereto. For example, the insulating layer 700 may be formed in a form in which a portion of the first and second grooves G are charged.

The insulating layer 700 may extend along the internal walls and the bottom surfaces of the first and second grooves G, and may not be in contact with a portion of the bottom surface of the groove. As the insulating layer 700 extends to the interior of the groove G, the insulating layer 700 may contact with the first and second extension portions 512 and 522 of the external electrode. However, the present disclosure is not limited thereto, and the insulating layer 700 may not come into contact with the extension portions 512 and 522.

The insulating layer 700 may include at least one selected from the group consisting of a thermoplastic resin such as a polystyrene-based resin, a vinyl acetate-based resin, a polyester-based resin, a polyethylene-based resin, a polypropylene-based resin, a polyamide-based resin, a rubber-based resin and an acrylic-based resin, a thermosetting resin such as a phenol-based resin, an epoxy-based resin, a urethane-based resin, a melamine-based resin and an alkyd-based resin, a photosensitive insulating resin, combinations thereof.

The insulating layer 700 may be formed by applying an insulating paste to an internal surface of the groove G on an external surface of the body 100 in which the groove G is formed, but the present disclosure is not limited thereto.

Other details are substantially the same as those described above in the description of the first example embodiment, and detailed descriptions will be omitted.

One embodiment of this invention has been described above, but a person skilled in the art may modify and change this invention in various ways by adding, changing, or deleting components within the scope of the patent claim.

Although one example embodiment of the present disclosure has been described above, it will be apparent to those skilled in the art that modifications and variations could be made in various ways by adding, changing, or deleting components within the scope of the patent claim, without departing from the scope of the present invention as defined by the appended claims, and will also be included within the scope of the present invention.

What is claimed is:

1. A coil component comprising:
a body having one surface and the other surface opposing each other, and a plurality of side surfaces connecting to the one surface and the other surface;
a coil embedded inside the body and having an end exposed to at least one of the side surfaces of the body;
an external electrode including a connection portion disposed on one of the side surfaces of the body and connected to the end of the coil, and an extension portion extending from the connection portion to the one surface of the body; and
a groove formed in the one surface of the body and having a bottom surface, substantially parallel to the one surface of the body, and an internal wall connecting the bottom surface to the one surface of the body,
wherein the extension portion of the external electrode extends along the internal wall and the bottom surface of the groove.

2. The coil component according to claim 1, wherein the extension portion of the external electrode is disposed on a portion of the groove.

3. The coil component according to claim 1, wherein the internal wall of the groove is parallel to at least one of the side surfaces of the body.

4. The coil component according to claim 1, wherein the extension portion of the external electrode extending to an interior of the groove is not in contact with a portion of the bottom surface of the groove.

5. The coil component according to claim 1, wherein the external electrode comprises:
a first electrode layer in contact with an end of the coil; and
a second electrode layer disposed on the first electrode layer,
wherein the first and second electrode layers extend to an interior of the groove.

6. The coil component according to claim 5, wherein a portion of the first and second electrode layers is disposed inside the groove.

7. The coil component according to claim 1, wherein the groove includes first and second grooves,
wherein the coil component further includes an insulating layer disposed on the one surface of the body and disposed between the first and second grooves.

8. The coil component according to claim 7, wherein the insulating layer extends to an interior of the first and second grooves.

9. The coil component according to claim 8, wherein the insulating layer fills a portion of the first and second grooves.

10. The coil component according to claim 8, wherein the insulating layer extending to the interior of the first and second grooves extend along surfaces of internal walls of the first and second grooves.

11. The coil component according to claim 10, wherein the insulating layer extending to the interior of the first and second grooves is in contact with a portion of bottom surfaces of the first and second grooves.

12. The coil component according to claim 8, wherein the insulating layer is in contact with the extension portion of the external electrode.

13. A coil component comprising:
a body having one surface and other surface opposing each other, and a plurality of side surfaces connecting to the one surface and the other surface;
a coil buried in the body and having an end exposed to the side surface of the body;
an external electrode including a connection portion disposed on at least one of the side surfaces of the body and connected to the end of the coil, and an extension portion extending from the connection portion to the one surface and the other surface of the body; and
a groove formed in the one surface of the body,
wherein the extension portion extends to an interior of the groove.
